(19) United States
(12) Patent Application Publication
(10) Pub. No.: US 2006/0291372 A1
(43) Pub. Date: Dec. 28, 2006

(54) Apparatus and method for reducing pilot overhead in a wireless communication system

(75) Inventors: Jin-Kyu Koo, Suwon-si (KR); Chang-Ho Suh, Seongnam-si (KR); Dong-Seek Park, Yongin-si (KR); Young-Kwon Cho, Suwon-si (KR); Eun-Taek Lim, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/474,558

(22) Filed: Jun. 26, 2006

(30) Foreign Application Priority Data
Jun. 24, 2005 (KR) 2005-0054737

(51) Int. Cl. H04J 11/00

(52) U.S. Cl. 370/208

(57) ABSTRACT

An apparatus and method for reducing pilot overhead in a broadband wireless communication system are provided. A data symbol mapper maps data symbols to be transmitted into subcarriers and detects values of the data symbols mapped into predefined subcarriers. A pilot generator determines masking codes for each pilot group by using the detected values of the data symbols and masks the determined masking codes into pilot symbols of the corresponding pilot group. A pilot symbol mapper maps the masked pilot symbols received from the pilot generator into subcarriers.

### PRIORITY

This application claims priority under 35 U.S.C. § 119 to an application entitled “Apparatus And Method For Reducing Pilot Overhead In A Wireless Communication System” filed in the Korean Intellectual Property Office on Jun. 24, 2005 and allocated Ser. No. 2005-54737, the contents of which are incorporated herein by reference.

### BACKGROUND OF THE INVENTION

1. Field of the Invention

The present invention relates generally to an apparatus and method for increasing data throughput in a broadband wireless communication system, and in particular, to an apparatus and method for reducing pilot overhead.

2. Description of the Related Art

Orthogonal Frequency Division Multiplexing (OFDM) is a data transmission scheme that can achieve high-speed data transmission using a multi-carrier scheme in cable/wireless channels. The OFDM uses multi-carrier modulation (MCM), in which a serial symbol sequence is converted into parallel symbol sequences and modulated into a plurality of mutually orthogonal subcarriers, that is, a plurality of subchannels.

In order to provide a coherent detection of data symbols, the OFDM communication system performs channel estimation prior to the detection of the data symbols. To accomplish this, a transmitter maps pilot symbols between the data symbols, and a receiver performs channel estimation using a change of the pilot symbol values. As the number of pilot symbols increases, the channel estimation performance is improved. However, increasing the number of pilot symbols reduces the number of the data symbols that can be transmitted, resulting in the decrease of data throughput. Therefore, there is a demand for a solution that can reduce pilot overhead, while maintaining the channel estimation performance at a predetermined level.

### SUMMARY OF THE INVENTION

An aspect of the present invention is to substantially solve at least the above problems and/or disadvantages and to provide at least the advantages below. Accordingly, an aspect of the present invention is to provide an apparatus and method for reducing pilot overhead in a broadband wireless communication system, while maintaining channel estimation performance.

Another aspect of the present invention is to provide an apparatus and method for increasing data throughput in a broadband wireless communication system, while maintaining channel estimation performance.

A further aspect of the present invention is to provide an apparatus and method for masking pilot symbols in accordance with a data symbol value and transmitting the masked pilot symbols in a broadband wireless communication system.

A further of the present invention is to provide an apparatus and method for using data symbols mapped at positions of subcarriers in channel estimation in a broadband wireless communication system.

According to one aspect of the present invention, in a transmitter of a broadband wireless communication system where at least one pilot symbol and at least one data symbol constitute a single pilot group, a data symbol mapper maps data symbols to be transmitted into subcarriers and detects values of the data symbols mapped into selected subcarriers. A pilot generator determines masking codes for each pilot group by using the detected values of the data symbols and masks the determined masking codes into pilot symbols of the corresponding pilot group. A pilot symbol mapper maps the masked pilot symbols received from the pilot generator into subcarriers.

According to another aspect of the present invention, in a receiver of a broadband wireless communication system where at least one pilot symbol and at least one data symbol constitute a single pilot group, an extractor extracts pilot symbols and data symbols from received data. A masking code detector correlates the extracted pilot symbols with masking codes and detects masking codes used in each pilot group. A channel estimator determines values of the data symbols mapped into each pilot group by using number of the detected masking codes and performs a channel estimation on the data symbols of the pilot group by using the determined values of the data symbols.

According to further aspect of the present invention, in a transmitting method of a broadband wireless communication system where at least one pilot symbol and at least one data symbol constitute a single pilot group, data symbols to be transmitted are mapped into subcarriers. Values of the data symbols mapped into subcarriers are checked. Masking codes for each pilot group are determined by using the checked values of the data symbols. Pilot symbols are masked with the determined masking codes. The masked pilot symbols are mapped into subcarriers.

According to further aspect of the present invention, in a receiving method of a broadband wireless communication system where at least one pilot symbol and at least one data symbol constitute a single pilot group, pilot symbols and data symbols are extracted from receive data. The extracted pilot symbols are correlated with masking codes, and masking codes used in each pilot group are detected. Values of the data symbols mapped into each pilot group are determined by using number of the detected masking codes. A channel estimation is performed on the data symbols mapped into the pilot group by using the determined values of the data symbols.

### BRIEF DESCRIPTION OF THE DRAWINGS

The above and other aspects, features and advantages of the present invention will become more apparent from the following detailed description when taken in conjunction with the accompanying drawings in which:

FIG. 1 is a graph illustrating a pilot mapping method according to the present invention;

FIG. 2 is a diagram illustrating a method for determining pilot masking codes according to the present invention;

FIG. 3 is a diagram illustrating a method for detecting pilot masking codes according to the present invention;

FIG. 4 is a block diagram of a transmitter of an OFDM communication system according to the present invention;

FIG. 5 is a block diagram of a masking pilot generator of FIG. 4 according to the present invention;

FIG. 6 is a block diagram of a receiver of an OFDM communication system according to the present invention;

FIG. 7 is a block diagram of a masking code detector of FIG. 6 according to the present invention;

FIG. 8 is a flowchart illustrating a transmitting method in the OFDM communication system according to the present invention; and

FIG. 9 is a flowchart illustrating a receiving method in the OFDM communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

A following description will be made about an apparatus and method for reducing pilot overhead in an OFDM communication system, while maintaining channel estimation performance.

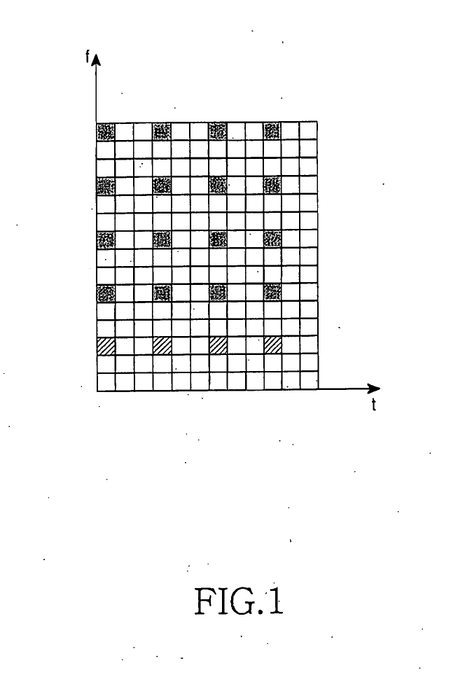

FIG. 1 is a graph illustrating a pilot mapping method according to the present invention. In FIG. 1, the x axis is a time (t) axis and a frequency (f) axis. A basic unit of the time axis is an OFDM symbol and a basic unit of the frequency axis is a subcarrier. That is, a single block represents a single subcarrier within a single OFDM symbol. Hatched blocks are pilot symbols and the blocks are data symbols. According to the present invention, among the data symbols, the hatched blocks are used as pilot symbols.

Referring to FIG. 1, four pilot symbols and a single data symbol are defined as a single pilot group. A transmitter maps data symbols into the hatched blocks, masks the other four pilot symbols with specific masking codes in accordance with values of the data symbols. For example, the masking codes may be Hadamard codes (or Walsh codes). A receiver detects the codes masked in the four pilot symbols and acquires values of the corresponding data symbols in accordance with the detected code values (i.e. code number). Because the receiver can know in advance the values of the data symbols, it can perform channel estimation using the data symbols.

Specifically, when a modulation order is “m”, the number of states of the data symbol is 2^{m}. Thus, a single data symbol and 2^{m} number of pilot symbols are defined as a single pilot group. When the data symbol is sᵢ and i ∈{1, 2, . . . , 2^{m}}, an i^{th} code Cᵢⱼ:1≦j≦2^{m} of the Hadamard code set {Cᵢⱼ:1≦i,j<2^{m}} is masked into 2^{m} number of the pilot symbols. The masking is an operation of multiplying the pilot symbols by the specific mask sequence (e.g. Hadamard code). The receiver correlates all codes of the Hadamard code set in each group with respect to the received pilot symbols, detects a maximum energy, and checks the code numbers masked into the pilot symbols. When the code number is i, the corresponding data symbol is sᵢ. Thus, this data symbol is considered the pilot symbol and used for the channel estimation.

As described above, the present invention can reduce the pilot overhead by mapping the data symbols serving as the pilot into the hatched rectangles.

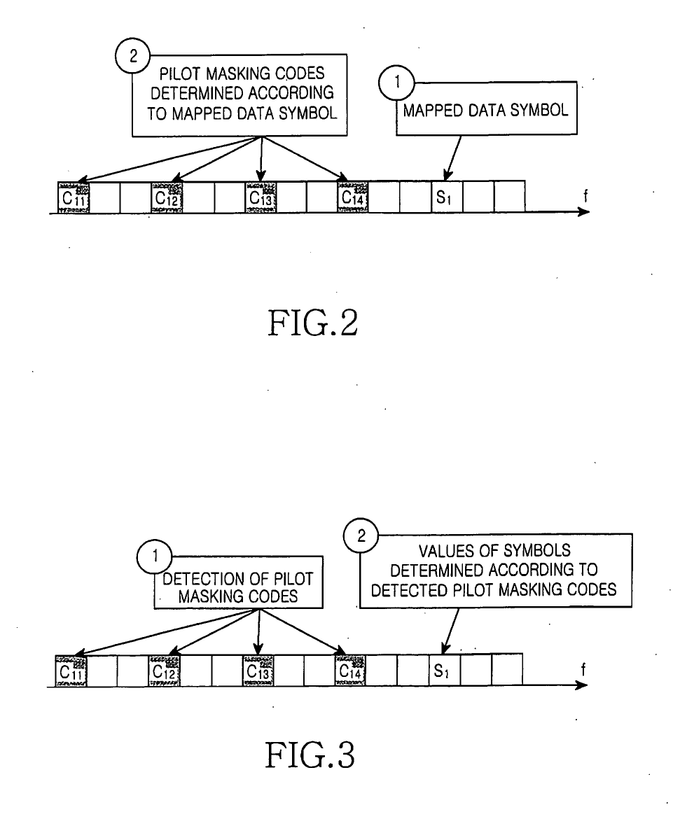

FIG. 2 is a diagram explaining a method for determining the pilot masking codes according to an embodiment of the present invention.

It is assumed that Quadrature Phase Shift Keying (QPSK) having a modulation order of 2 is used. Because the modulation order is 2, a Hadamard code set having a length of 4 is required for the pilot masking. Four pilot symbols and a single data symbol are defined as a single pilot group. Although symbols of the single pilot group are equally spaced apart from one another in the frequency axis, the number and arrangement of the symbols constructing the single pilot group can be changed depending on the specification and designs. That is, the positions of the symbols can be freely arranged in a frequency-time-space plane. As illustrated in FIG. 2, the transmitter checks the values of the data symbols mapped at predetermined positions within the pilot group. Then, the pilot symbols within the same group are masked with the corresponding Hadamard codes in accordance with the checked values of the data symbols. For example, when the checked value of the data symbol is si, four pilot symbols within the same group are masked with a first Hadamard code (C₁₁ C₁₂ C₁₃ C₁₄) having a length of 4.

FIG. 3 is a diagram illustrating a method for detecting the pilot masking codes according to the present invention.

Like in FIG. 2, it is assumed that QPSK having a modulation order of 2 is used and a data symbol having a state value of s₁, is transmitted. That is, it is assumed that the pilot symbols are masked with the first Hadamard code. As illustrated in FIG. 2, the receiver detects a maximum energy by correlating all Hadamard codes that are available to the received pilot symbols. At this point, it is determined if the first Hadamard code is masked. If the first Hadamard code masked, it can be determined that the data symbol located at the predefined position is s₁. The receiver can know the masked codes of the pilot symbols and the values of the data symbols. Therefore, the receiver can perform the channel estimation (and noise estimation, etc.) using all of the five symbols.

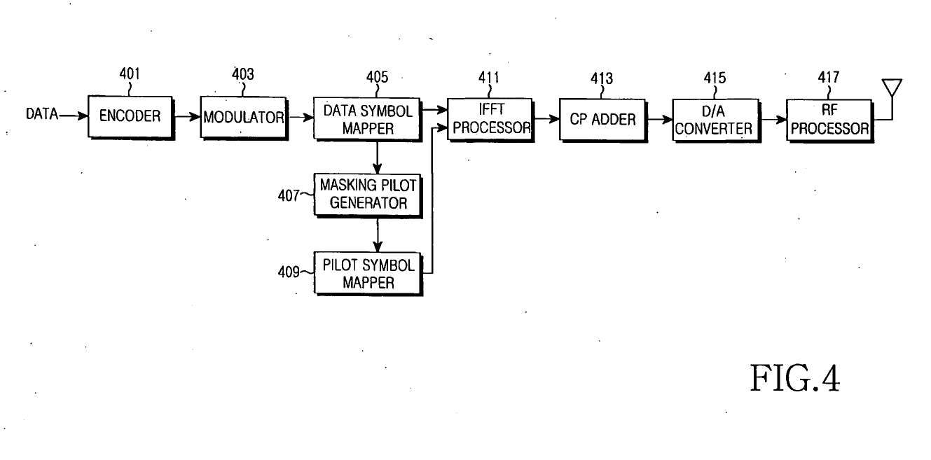

FIG. 4 is a block diagram of the transmitter of the OFDM communication system according to the present invention.

Referring to FIG. 4, the transmitter includes an encoder 401, a modulator 403, a data symbol mapper 405, a masking pilot generator 407, a pilot symbol mapper 409, an inverse fast Fourier transform (IFFT) processor 411, a cyclic prefix (CP) adder 413, a digital/analog (D/A) converter 415, and an RF processor 417.

The encoder 401 encodes an incoming data bit sequence at a given coding rate and generates coded bits. The encoder 401 may be implemented using a convolution encoder, a turbo encoder, or a Low Density Parity Check (LDPC) encoder.

The modulator 403 maps the symbols received from the encoder 401 in accordance with a given modulation scheme (modulation order) and outputs complex symbols. Examples of the modulation scheme include a Binary Phase Shift Keying (BPSK) mapping 1 bit (s=1) to a single signal point (complex symbol), a Quadrature Phase Shift Keying (QPSK) mapping 2 bits (s=2) to a single complex symbol, a 8-ary Quadrature Amplitude Modulation (8QAM) mapping 3 bits (s=3) to a single complex symbol, a 16QAM mapping 4 bits (s=4) to a single complex symbol, and a 64QAM mapping 6 bits (s=6) to a single complex symbol.

The data symbol mapper 405 maps the data symbols received from the modulator 403 into subcarriers. The mapping of the data symbols into the subcarriers means that the respective data symbols are provided to the corresponding inputs (position of the subcarriers) of the IFFT processor 411. At this point, the data symbol mapper 405 detects values of the data symbols mapped to the predefined positions of the subcarriers and provides the detected values to the masking pilot generator 407. For example, in FIG. 1, the values of the data symbols mapped to the hatched rectangles are detected and provided to the masking pilot generator 407.

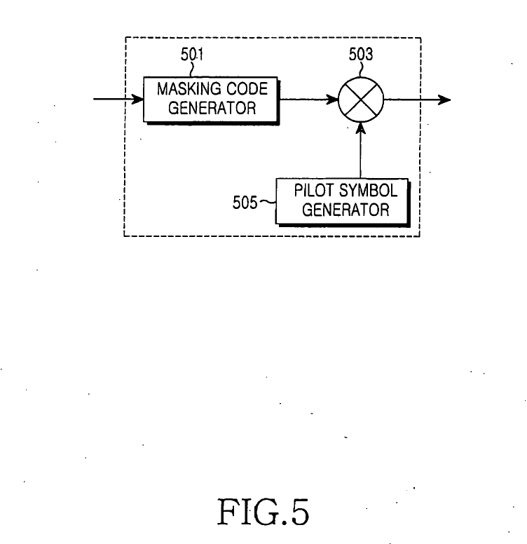

Using the values of the data symbols, the masking pilot generator 407 determines masking codes (e.g., Hadamard codes) that will be used in each pilot group, and masks the determined masking codes into the pilot symbols of the corresponding pilot group. For example, when the modulation scheme is QPSK and the state value of the data symbol within the first pilot group is S₂, four pilot symbols within the first pilot group are masked using a second Hadamard code. The masking pilot generator 407 will be described in detail with reference to FIG 5.

The pilot symbol mapper 409 maps the masked pilot symbols received from the masking pilot generator 407 into subcarriers. That is, the respective masked pilot symbols are provided to the predefined inputs (positions of the subcarriers) of the IFFT processor 441.

The IFFT processor 441 IFFT-processes the data symbols from the data symbol mapper 405 and the symbols from the pilot symbol mapper 409 and outputs time-domain sample data. The CP adder 413 copies the rear parts of the time-domain sample data and adds the copied parts to the front of the sample data, thereby outputting OFDM symbols.

The D/A converter 415 converts the sample data from the CP adder 413 into analog signals. The RF processor 417 includes a filter and a front end unit. The RF processor 417 RF-processes the output signals of the D/A converter 415 and transmits the RF-processed signals through TX antenna over a wireless channel. The signals transmitted from the transmitter undergo a multi-channel and are input in a noise-added state through RX antenna to the receiver.

FIG. 5 is a block diagram of the masking pilot generator of FIG. 4 according to an embodiment of the present invention.

Referring to FIG. 5, the masking pilot generator 407 includes a masking code generator 501, a multiplier 503, and a pilot symbol generator 505.

Using the values of the data symbols received from the data symbol mapper 405, the masking code generator 501 determines masking codes (e.g., Hadamard codes) that will be used in each pilot group, and generates the determined Hadamard codes. The pilot symbol generator 505 generates pilot symbols having predefined values. The multiplier 503 multiplies the pilot symbols received from the pilot symbol generator 505 by the masking codes (e.g. Hadamard codes) received from the masking code generator 501. These masked pilot symbols are provided to the pilot symbol mapper 409 of FIG. 4.

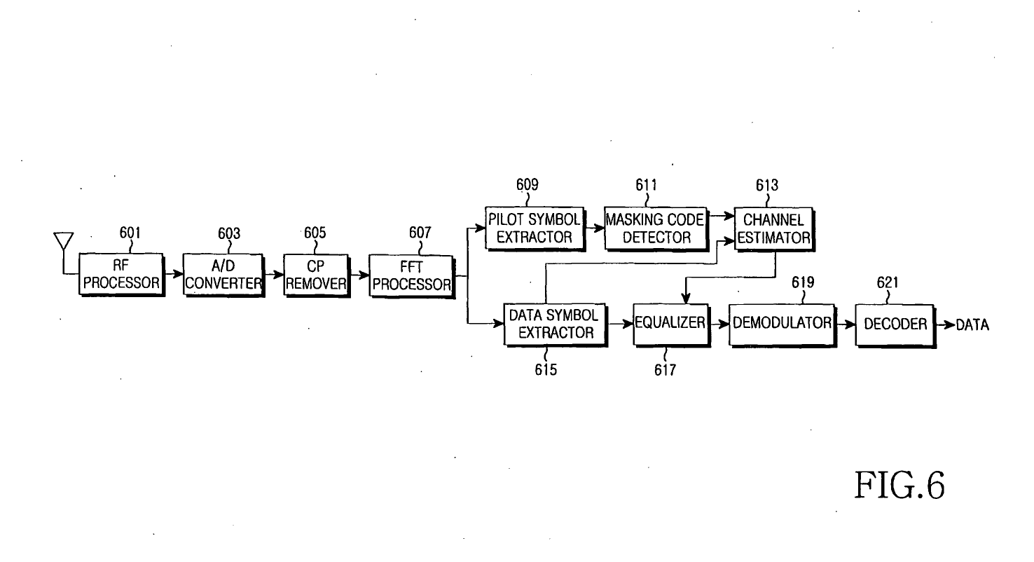

FIG. 6 is a block diagram of the receiver of the OFDM communication system according to the present invention.

Referring to FIG. 6, the receiver includes an RF processor 601, an analog/digital (A/D) converter 603, a CP remover 605, an FFT processor 607, a pilot symbol extractor 609, a masking code detector 611, a channel estimator 613, a data symbol extractor 615, an equalizer 617, a demodulator 619, and a decoder 621.

The RF processor 601 includes a front end unit and a filter. The RF processor 601 converts RF signals passing through a wireless channel into baseband signals. The A/D converter 603 converts the analog baseband signals received from the RF processor 601 into digital signals.

The CP remover 605 removes the CP from the output data of the A/D converter 603. The FFT processor 607 FFT-processes the data received from the CP remover 607 and outputs frequency-domain data.

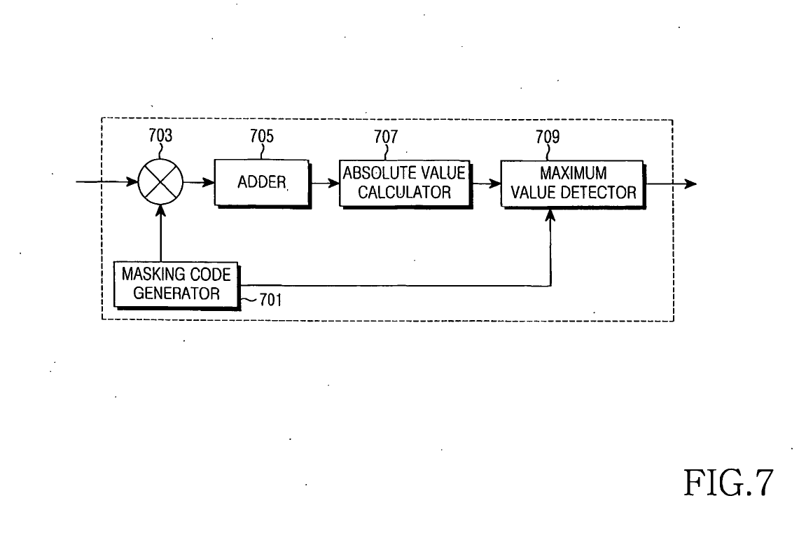

The pilot symbol extractor 609 extracts pilot symbols from the frequency-domain data. The masking code detector 611 performs a correlation search on the pilot symbols received from the pilot symbol extractor 609 and detects masking codes. Then, the masking code detector 611 outputs pilot symbols in which number of the detected masking codes and the masking codes are removed. The masking code detector 611 will be described later in detail with reference to FIG. 7.

The data symbol extractor 615 extracts data symbols from the output data of the FFT processor 607 and outputs the extracted data symbols to the equalizer 617. At this point, the data symbols located at the predefined positions are also output to the channel estimator 613. For example, in FIG. 1, the data symbols mapped to the hatched rectangles are output to the channel estimator 613.

The channel estimator 613 determines values of the data symbols mapped to each pilot group in accordance with number of the masking codes received from the masking code detector 611, and performs the channel estimation on the data symbols received from the data symbol extractor 615 using the determined values of the data symbols. Also, the channel estimator 613 performs the channel estimation on the pilot symbols received from the masking code detector 611 using the previously known values of the pilot symbols. Then, the channel estimator 613 provides the channel estimation result to the equalizer 617.

The equalizer 617 performs channel estimation on the data symbols output from the data symbol extractor 615 using the channel estimation result. That is, the equalizer 617 compensates for various distortions occurring in the wireless channel.

The demodulator 619 demodulates the symbols received from the equalizer 617 in accordance with the modulation scheme of the transmitter and outputs coded data. The decoder 621 decodes the coded data received from the demodulator 619 in accordance with the coding scheme of the transmitter and recovers the original data.

FIG. 7 is a block diagram of the masking code detector 611 of FIG. 6 according to the present invention.

Referring to FIG. 7, the masking code detector 611 includes a masking code generator 701, a multiplier 703, an adder 705, an absolute value calculator 707, and a maximum value detector 709. Also, the masking code detector 611 may further include a buffer for temporarily storing the symbols received from the pilot symbol extractor 609, and a buffer for temporarily storing the pilot symbols from which the masking codes are removed.

The masking code generator 701 sequentially generates codes of a Hadamard code group having a predetermined length with respect to each pilot group. The masking code generator 701 provides number of the Hadamard code to the multiplier 703 and the maximum value detector 709.

The multiplier 703 multiplies a number of the pilot symbols of a single pilot group by the masking codes received from the masking code generator 701. If the number of the Hadamard codes constructing the Hadamard code group is 4, the multiplier 703 performs four times the multiplication operation with respect to the single pilot group.

The adder 705 adds the output values of the multiplier 703. For example, when the length of the Hadamard code is 4, the multiplier 703 outputs four values and the adder 704 adds the four values.

The absolute value calculator 707 calculates an absolute value of the value received from the adder 705. The maximum value detector 709 detects a maximum value (or peak) from the absolute values outputted from the absolute value calculator 707. Then, the maximum value detector 709 outputs number of the Hadamard code, in which the maximum value is detected, to the channel estimator 613. Also, the corresponding pilot symbols in which the masking codes are removed are outputted to the channel estimator 613.

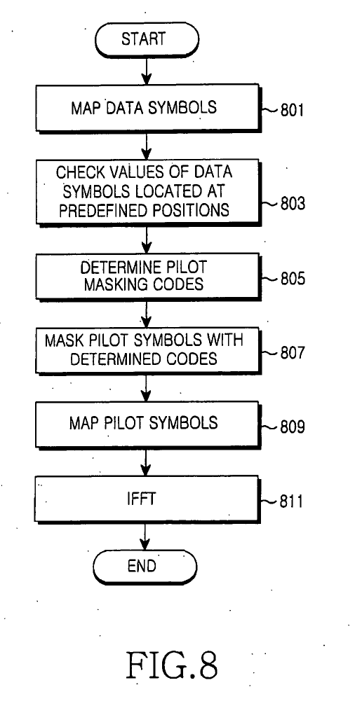

FIG. 8 is a flowchart illustrating a transmitting method in the OFDM communication system according to the present invention.

Referring to FIG. 8, the transmitter encodes data to be transmitted in accordance with a coding scheme and modulates the coded data in accordance with a modulation scheme. In step 801, when the data symbols are generated, the data symbols (modulation symbols) to be transmitted are mapped into subcarriers. In step 803, the transmitter checks the values of the data symbols allocated to the predefined positions (positions of the subcarriers). For example, in FIG. 1, the transmitter checks the values of the data symbols mapped into the hatched blocks.

In step 805, using the checked values of the data symbols, the transmitter determines masking codes that will be used in each pilot group. For example, when the modulation scheme is QPSK and the state value of the data symbol is si, the first Hadamard code (C₁₁ C₁₂ C₁₃ C₁₄) is determined as the masking codes that will be used in the same group.

In step 807, when the masking codes are determined, the transmitter masks the pilot symbols using the determined Hadamard code in each pilot group. In step 809, the masked pilot symbols are mapped into the subcarriers.

In step 811, the data symbols mapped into the subcarriers and the masked pilot symbols are IFFT-processed. Then, the IFFT-processed signals are RF-processed and transmitted through the TX antenna.

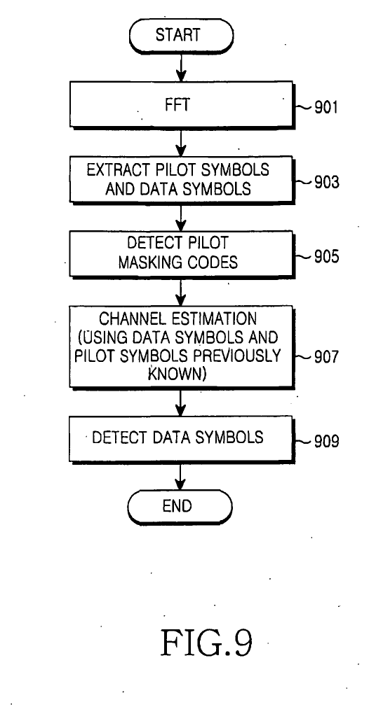

FIG. 9 is a flowchart illustrating a receiving method in the OFDM communication system according to an embodiment of the present invention.

Referring to FIG. 9, in step 901, the receiver converts the received RF signals into baseband sample data. Then, the receiver FFT-processes the sample data and generates frequency-domain data. In step 903, the receiver extracts the pilot symbols and the data symbols from the frequency-domain data.

In step 905, the receiver classifies the extracted pilot symbols into the pilot groups and detects the pilot masking codes in each group. At this point, the pilot symbols in which the masking codes are removed are acquired. For example, the pilot symbols contained in the single group are inverse-fast-Hadamard converted. Then, the Hadamard code in which the peak (maximum value) is detected is determined as the pilot masking code.

In step 907, when the pilot symbols in which number of the masking codes and the masking codes are removed are acquired, the receiver performs the channel estimation using the data symbols mapped at the predefined positions and the pilot symbols in which the masking codes are removed. Because the values of the data symbols mapped at the predefined positions are determined using number of the masking code, the channel estimation can be performed using the data symbols.

In step 909, the receiver performs the channel compensation on the data symbols using the channel estimation result. Then, the receiver demodulates and decodes the channel-estimated symbols and recovers the original data.

As described above, when the modulation order is “m”, one pilot symbol is further generated at every 2^{m} pilot symbols. Thus, the pilot overhead can be reduced by 1/(2^{m}+1). Also, data can be further transmitted by the reduced pilot overhead, resulting in the increase of data throughput.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A transmitter in a wireless communication system where at least one pilot symbol and at least one data symbol constitute a single pilot group, comprising:
a data symbol mapper for mapping data symbols to be transmitted into subcarriers, and detecting values of the data symbols mapped into selected subcarriers;
a pilot generator for determining masking codes for each pilot group by using the detected values of the data symbols, and masking the masking codes into pilot symbols of the corresponding pilot group; and
a pilot symbol mapper for mapping the masked pilot symbols received from the pilot generator into subcarriers.

2. The transmitter of claim 1, further comprising:
an encoder for encoding data to be transmitted; and
a modulator for modulating the encoded data received from the encoder and generating the data symbols.

3. The transmitter of claim 1, further comprising:
an inverse fast Fourier transform (IFFT) processor for IFFT-processing the data symbols and the masked pilot symbols mapped into the subcarriers and generating baseband sample data; and
a converter for converting the baseband sample data into radio frequency (RF) signals.

4. The transmitter of claim 1, wherein the masking codes are Hadamard codes.

5. The transmitter of claim 1, wherein number of the data symbols and number of the pilot symbols in the pilot group are determined by modulation order.

6. The transmitter of claim 1, wherein the pilot generator comprises:
a masking code generator for determining the masking codes for each pilot group by using the values of the data symbols received from the data symbol mapper and generating the determined masking codes;
a pilot symbol generator for generating pilot symbols having a predefined value; and
a multiplier for multiplying the pilot symbols received from the pilot symbol generator by the masking codes received from the masking code generator.

7. A receiver in a wireless communication system where at least one pilot symbol and at least one data symbol constitute a single pilot group, comprising:
an extractor for extracting pilot symbols and data symbols from receive data;
a masking code detector for correlating the extracted pilot symbols with predefined masking codes and detecting masking codes used in each pilot group; and
a channel estimator for determining values of the data symbols mapped into each pilot group by using a number of the detected masking codes and performing a channel estimation on the data symbols of the pilot group by using the determined values of the data symbols.

8. The receiver of claim 7, further comprising:
a converter for converting received RF signals into baseband sample data; and
an FFT processor for FFT-processing the sample data and generating the receive data.

9. The receiver of claim 7, further comprising:
an equalizer for performing a channel compensation on the extracted data symbols using a channel estimation result received from the channel estimator;
a demodulator for demodulating the data received from the equalizer and generating code symbols; and
a decoder for decoding the symbols received from the demodulator and recovering original data.

10. The receiver of claim 7, wherein the masking code detector comprises:
a masking code generator for sequentially generating codes of a Hadamard code group in each pilot group;
a correlator for correlating the extracted pilot symbols with the Hadamard codes received from the masking code generator; and
a maximum value detector for detecting a peak of correlation values received from the correlator and providing to the channel estimator a number of the Hadamard code in which the peak is detected.

11. The receiver of claim 7, wherein the masking code detector comprises:
an operator for performing a correlation search on the received pilot symbols in each pilot group; and
a maximum value detector for detecting a peak of correlation values received from the operator and providing to the channel estimator a number of a Hadamard code in which the peak is detected.

12. The receiver of claim 7, wherein the masking codes are Hadamard codes.

13. The receiver of claim 7, wherein number of the data symbols and number of the pilot symbols in the pilot group are determined by modulation order.

14. The receiver of claim 7, wherein the channel estimator performs the channel estimation on pilot symbols in which the masking codes are removed.

15. A transmitter in a wireless communication system where at least one pilot symbol and at least one data symbol constitute a single pilot group, comprising:
a pilot generator for masking pilot symbols of same group into specific codes in accordance with values of data symbols of each pilot group; and
a mapper for mapping data symbols to be transmitted and the masked pilot symbols into subcarriers.

16. The transmitter of claim 15, further comprising:
an inverse fast Fourier transform (IFFT) processor for IFFT-processing the data symbols and the masked pilot symbols mapped into the subcarriers and generating baseband sample data; and
a converter for converting the baseband sample data into radio frequency (RF) signals.

17. The transmitter of claim 15, wherein the pilot generator comprises:
a masking code generator for determining the masking codes to be used in each pilot group by using the values of the data symbols and generating the determined masking codes;
a pilot symbol generator for generating pilot symbols having a predefined value; and
a multiplier for multiplying the pilot symbols received from the pilot symbol generator by the masking codes received from the masking code generator.

18. A receiver in a wireless communication system where at least one pilot symbol and at least one data symbol constitute a single pilot group, comprising:
a detector for detecting codes masked on pilot group basis with respect to received pilot symbols; and
a channel estimator for determining values of data symbols mapped into a corresponding pilot group by using number of the detected masking codes and performing a channel estimation on the data symbols of the pilot group by using the determined values of the data symbols.

19. The receiver of claim 18, wherein the detector comprises:
an operator for performing a correlation search on the received pilot symbols in each pilot group; and
a maximum value detector for detecting a peak of correlation values received from the operator and providing to the channel estimator a number of a Hadamard code, in which the peak is detected.

20. A transmitting method in a wireless communication system where at least one pilot symbol and at least one data symbol constitute a single pilot group, comprising:
mapping data symbols to be transmitted into subcarriers;
checking values of the data symbols mapped into selected subcarriers;
determining masking codes for each pilot group by using the checked values of the data symbols;
masking pilot symbols with the determined masking codes; and
mapping the masked pilot symbols into subcarriers.

21. The transmitting method of claim 20, further comprising:
encoding data to be transmitted; and
modulating the encoded data and generating the data symbols.

22. The transmitting method of claim 20, further comprising:
inverse fast Fourier transform (IFFT)-processing the data symbols and the masked pilot symbols mapped into the subcarriers and generating baseband sample data; and
converting the baseband sample data into radio frequency (RF) signals.

23. The transmitting method of claim 20, wherein the masking codes are Hadamard codes.

24. The transmitting method of claim 20, wherein number of the data symbols and number of the pilot symbols in the pilot group are determined by modulation order.

25. A receiving method in a wireless communication system where at least one pilot symbol and at least one data symbol constitute a single pilot group, comprising:
extracting pilot symbols and data symbols from receive data;
correlating the extracted pilot symbols with predefined masking codes and detecting masking codes used in each pilot group;
determining values of the data symbols mapped into each pilot group by using number of the detected masking codes; and
performing a channel estimation on the data symbols mapped into the pilot group by using the determined values of the data symbols.

26. The receiving method of claim 25, further comprising performing a channel estimation on pilot symbols in which the masking codes are removed.

27. The receiving method of claim 25, further comprising:
converting incoming radio frequency (RF) signals into baseband sample data; and
fast Fourier transform (FFT)-processing the sample data and generating the receive data.

28. The receiving method of claim 25, further comprising:
performing a channel estimation on the extracted data symbols using the channel estimation result;
demodulating the channel-estimated data and generating code symbols; and
decoding the code symbols and recovering original data.

29. The receiving method of claim 25, wherein the masking code detecting step comprises:
sequentially generating codes of a Hadamard code group in each pilot group;
correlating the pilot symbols with the Hadamard codes; and
detecting a peak of the correlation values and determining as the masking codes a number of the Hadamard code in which the peak is detected.

30. The receiving method of claim 25, wherein the masking code detecting step comprises:
performing a correlation search on the received pilot symbols in each pilot group; and
detecting a peak of the correlation search values and determining as the masking codes a number of a Hadamard code in which the peak is detected.

31. The receiving method of claim 25, wherein the masking codes are Hadamard codes.

32. The receiving method of claim 25, wherein number of the data symbols and number of the pilot symbols in the pilot group are determined by modulation order.

33. A transmitting method in a wireless communication system where at least one pilot symbol and at least one data symbol constitute a single pilot group, comprising:
masking pilot symbols of same group with specific codes in accordance with values of data symbols of each pilot group; and
mapping data symbols to be transmitted and the masked pilot symbols into subcarriers in accordance with a predefined scheme.

34. The transmitting method of claim 33, further comprising:
inverse fast Fourier transform (IFFT)-processing the data symbols and the masked pilot symbols mapped into the subcarriers and generating baseband sample data; and
converting the baseband sample data into radio frequency (RF) signals.

35. A receiving method in a wireless communication system where at least one pilot symbol and at least one data symbol constitute a single pilot group, comprising:
detecting codes masked on pilot group basis with respect to received pilot symbols; and
determining values of data symbols mapped into a corresponding pilot group by using number of the detected masking codes; and
performing a channel estimation on the data symbols of the pilot group by using the determined values of the data symbols.

36. The receiving method of claim 35, wherein the detecting step comprises:
performing a correlation search on the received pilot symbols in each pilot group; and
detecting a peak of the correlation search values and determining as the masking codes a number of a Hadamard code in which the peak is detected.

37. A wireless communication device where a single pilot group constitutes a plurality of pilot symbol and data symbol, comprising:
a data symbol mapper for mapping data symbols, and detecting values of the mapped data symbols mapped;
a pilot generator for determining masking codes for pilot group using the detected values of the data symbols, and masking the masking codes into pilot symbols of the corresponding pilot group; and
a pilot symbol mapper for mapping the masked pilot symbols received from the pilot generator.

38. A wireless communication device where a single pilot group constitutes a plurality of pilot symbol and data symbol, comprising:
an extractor for extracting pilot symbols and data symbols from received data;
a masking code detector for correlating the extracted pilot symbols with predefined masking codes and detecting masking codes used in each pilot group; and
a channel estimator for determining values of the data symbols mapped into each pilot group using a number of the detected masking codes.

39. A wireless communication device where a single pilot group constitutes a plurality of pilot symbol and data symbol, comprising:
a pilot generator for masking pilot symbols of same group into specific codes in accordance with values of data symbols of each pilot group; and
a mapper for mapping data symbols to be transmitted and the masked pilot symbols into subcarriers.

40. A wireless communication device where a single pilot group constitutes a plurality of pilot symbol and data symbol, comprising:
a detector for detecting codes masked on pilot group basis with respect to received pilot symbols; and
a channel estimator for determining values of data symbols mapped into a corresponding pilot group using number of the detected masking codes.
